(19) United States
(12) Patent Application Publication
(10) Pub. No.: US 2016/0349880 A1
(43) Pub. Date: Dec. 1, 2016

(54) DEVICES AND METHODS FOR GENERATING HAPTIC WAVEFORMS

(71) Applicants: Tanvas Corporation, Chicago, IL (US); Northwestern University, Evanston, IL (US)

(72) Inventors: James E. Colgate, Evanston, IL (US); Michael F.D. Olley, Lake Zurich, IL (US); Michael A. Peshkin, Evanston, IL (US)

(73) Assignees: Tanvas Corporation, Chicago, IL (US); Northwestern University, Evanston, IL (US)

(21) Appl. No.: 15/117,277

(22) PCT Filed: Feb. 20, 2015
(86) PCT No.: PCT/US15/16914

§ 371 Date: Aug. 8, 2016

Related U.S. Application Data
(60) Provisional application No. 61/942,997, filed on Feb. 21, 2014.

(51) Int. Cl. G06F 3/044; G06F 3/01

(52) U.S. Cl. CPC G06F 3/044; G06F 3/016; G06F 2203/04104

(57) ABSTRACT

A controller for a surface haptic device that generates haptic waveforms and a method of generating desired haptic waveforms on a touch interface having a substrate and one or more electrodes connected to a front surface of the substrate are disclosed. The controller has a signal generator and a low pass filter, and automatically determines an on/off state of each of one or more surface haptic actuators such that a low pass filtered version of the on/off state closely approximates a desired waveform.

### CROSS-REFERENCE TO RELATED APPLICATION

This application claims the benefit and priority of U.S. Provisional Patent Application Ser. No. 61/942,997, filed Feb. 21, 2014, the disclosure of which is hereby incorporated herein by reference in its entirety.

### CONTRACTUAL ORIGIN OF THE INVENTION

This invention was made with government support under grant number IIP-1330966 awarded by the National Science Foundation. The government has certain rights in the invention.

### FIELD OF THE INVENTION

The present invention generally relates to touch interfaces for surface haptic devices (SHD), and more particularly to devices and methods for generating haptic waveforms for touch interfaces.

### BACKGROUND OF THE INVENTION

Touch interfaces can be found in laptop computers, gaming devices, automobile dashboards, kiosks, operating rooms, factories, automatic tellers, and a host of portable devices such as cameras and phones. Touch interfaces provide flexible interaction possibilities that discrete mechanical controls do not. But today's touch interfaces sacrifice an important part of the human experience: haptics. “Haptics” refers to the perceptual system associated with touch. Haptics lets us touch type, find a light switch in the dark, wield a knife and fork, enjoy petting a dog or holding our spouse's hand. Haptics is not just about moving one's hands, but it is about feeling things, recognizing objects (even without looking at them), and controlling the way that we interact with the world.

Haptics in the form of vibration is a familiar feature of electronic products such as pagers, cell phones, and smart phones. Although vibration has long been used as a silent ringer or alarm, it is increasingly used to provide tactile feedback to the human hand (especially the fingertips) when using a touch surface, such as a touch screen. Prior art, such as U.S. Pat. No. 6,429,846 entitled, “Haptic Feedback for Touchpads and Other Touch Controls, for instance, describe a number of hardware and software solutions for vibration-based haptic feedback. The technology is considerably more advanced than what was traditionally used in pagers. The use of piezoelectric actuators to enable high bandwidth control of vibration profiles enhances user experience. Nonetheless, the vibration approach has certain drawbacks. For instance, the entire device vibrates so that any effect is felt in the hand holding the device as well as at the fingertip touching the touch surface or screen. Furthermore, it does not support multi-point haptics: because the entire device vibrates, each fingertip touching the screen experiences the same effect.

### Multi-Point Haptics

Recently, electrostatic actuation has been explored as a means to generate vibrations localized to the fingertip by companies, such as Senseg Corporation, and Nokia, as well as by the present inventors. A co-pending patent application by some of the present inventors (U.S. patent application Ser. No. 13/468,818, entitled Electrostatic Multi-touch Haptic Display) describes a number of ways of achieving multi-point electrostatic haptics as well as integrating fingertip position sensing and haptic actuation or output. Certain aspects of that disclosure are noted herein as a background. For instance, the basis of electrostatic haptics is the modulation of frictional force as a result of directly affecting the normal force between the finger and a touch surface of a touch interface via an electric field. The electric field is established at the point of contact between the fingertip and the touch surface. This is accomplished by placing one or more electrodes on the touch surface of the substrate, insulating those electrodes from the fingertip with a dielectric layer. To set up an electric field, a circuit must be closed through the fingertip that touches the touch surface. There are two principal ways of doing this.

In the prior art, others have taught the method shown in FIG. 1a, which is a figure from U.S. Pat. No. 7,924,144, wherein capacitance of a finger-dielectric-electrode system is part of a circuit that is closed through a second contact at some other part of the body, which circuit may even be completed taking advantage of the relatively large capacitance of the human body. Thus, FIG. 1a shows an apparatus which implements a capacitive electrosensory interface, having an electrical circuit that is closed between two separate contact or touch locations, wherein both of the two locations are fingertips.

The present inventors have devised an alternative method shown in FIG. 1b, which is similar to a figure from U.S. patent application Ser. No. 13/468,695, entitled Touch Interface Device And Method For Applying Controllable Shear Forces To A Human Appendage, wherein two separate electrodes E and E′ (haptic devices) are covered by an insulating layer L and would be placed on a front or top surface of a substrate (not shown) at a single contact or touch location. The circuit is therefore closed through a single touch of a fingertip itself, not involving the rest of the body. This has the benefit of not requiring involvement of some other part of the body, but it has another benefit as well, which will be discussed herein.

To apply the two-electrode technique, it is necessary to create a suitable array of electrode pairs on the touch surface. As illustrated in FIG. 2, one approach the inventors have taught in the aforementioned application to accomplish this arrangement for an apparatus would be to tile a top surface or touch surface with lines of electrodes, such as electrodes 20 and 22. This layer of electrodes has the advantages that electrodes 20, 22 can be placed precisely where they are needed on the surface and that all electrodes of a respective type can potentially be patterned from the same conductive layer. It will be appreciated that wires can be patterned from the same conductive material as the electrodes, or can be made of higher conductivity material.

The array shown for example in FIG. 2 may be referred to as a “Lattice.” The diagram in FIG. 2 focuses on the electrode array, for ease of understanding. While a pattern in the form of a lattice network of lines of diamond-shaped electrodes is shown, such a pattern and shape of electrodes need not be used, but the emphasis is on covering the surface (here shown as being generally planar) with N*M electrodes that can serve in pairs. In this figure, electrodes 20 run in lines along or parallel to a first axis (for example the x-axis), and electrodes 22 run in lines along or parallel to a second axis (for example the y-axis). The region where a given y-axis electrode 22 crosses a given x-axis electrode 20 defines a two-electrode region (like that shown in FIG. 1b) where electrostatic forces can be applied to a user's skin, such as to a fingertip.

As shown in FIG. 2, any electrode 20 (x-axis) and electrode 22 (y-axis) can form a pair. If different voltages are applied to, for example, the electrodes 20 and 22, then an intersection of the respective lines of electrodes 20, 22 becomes an active region or location where a finger will experience increased electrostatic force. In practice, AC voltages may be used and maximum electrostatic forces are produced when the applied voltages are 180 degrees out of phase with one another.

### SUMMARY OF THE INVENTION

The purpose and advantages of the disclosed subject matter will be set forth in and apparent from the description and drawings that follow, as well as will be learned by practice of the claimed subject matter. The present disclosure generally provides systems and methods having electronic controllers for touch interfaces that provide for simultaneous sensing and actuation that facilitate multi-point haptics.

The present disclosure generally provides novel and non-obvious systems and methods for producing multi-point haptics, which the present inventors term “simultaneous sensing and actuation” (SSA). The present disclosure provides a controller for a surface haptic device that generates haptic waveforms, and a method of generating desired haptic waveforms on a touch interface having a substrate and one or more electrodes connected to a front surface of the substrate. Thus, the present disclosure makes use of a single array of electrodes disposed on the front surface of a touch substrate that may serve as both surface haptics devices and sensing devices.

In a first aspect, the present disclosure presents a controller for a surface haptic device that generates haptic waveforms, wherein the controller comprises a signal generator and a low pass filter, and the controller automatically determines an on/off state of each of one or more surface haptic actuators such that a low pass filtered version of the on/off state closely approximates a desired waveform.

In a second aspect, the disclosure presents a method of generating desired haptic waveforms on a touch interface of a surface haptic device having a substrate and one or more electrodes connected to a front surface of the substrate comprising: passing a representation of an actual waveform in real time through a low pass filter; comparing a resulting signal to a desired waveform; generating an error signal that depends on whether the low passed actual waveform is less than or greater than the desired waveform; utilizing the error signal in continuing or discontinuing pulses on a given electrode and/or increasing or decreasing the number of electrodes receiving pulses.

It will be appreciated that for touch interfaces disclosed herein the one or more electrodes that provide electrostatic actuation for haptic effects also may provide capacitance-based sensing of finger location on the front surface of the substrate.

It is to be understood that both the foregoing general description and the following detailed description are exemplary and provided for purposes of explanation only, and are not restrictive of the subject matter claimed. Further features and objects of the present disclosure will become more fully apparent from the following detailed description, taken with the following drawings, and from the appended claims.

### BRIEF DESCRIPTION OF THE DRAWINGS

In describing the example embodiments, reference is made to the accompanying drawing figures wherein like parts have like reference numerals, and wherein:

FIG. 1a is a figure from a prior art patent of an apparatus which implements a capacitive electrosensory interface, having an electrical circuit that is closed between two separate contact locations that are contacted by two different fingers.

FIG. 1b is a portion of a figure from a co-pending application by the present inventors which shows closing of an electrical circuit through two different electrodes at the same contact location by a single finger.

FIG. 2 is a diagram of an arrangement of electrodes for an apparatus that are in a first example pattern referred to as a lattice network.

FIG. 3 is a diagram of ten different waveforms that may be tracked, of the many that might be conceived as desirable for an effective haptic actuation method, with the vertical axis representing electrostatic force and the horizontal axis representing time.

FIG. 4 is a diagram showing a single pulse of voltage on a single electrode.

FIG. 5 has an upper diagram showing a voltage applied to a single electrode during a typical segment of a haptic output, and a lower diagram showing a corresponding force profile.

FIG. 6 is a simplified block diagram of a an algorithm for emulating a desired waveform.

FIG. 7a is a diagram showing an example desired waveform.

FIG. 7b is a diagram showing an output of a low pass filter that appears to quite closely track the example desired waveform of FIG. 7a.

FIG. 7c is a diagram showing the input to the low pass filter, which represents the states of the electrodes.

It should be understood that the drawings are not to scale. While some mechanical details of a touch interface device, including details of fastening means and other plan and section views of the particular arrangements, have not been included, such details are considered well within the comprehension of those of skill in the art in light of the present disclosure. It also should be understood that the present invention is not limited to the example embodiments illustrated and that the examples are shown in simplified form, so as to focus on the principles, systems and methods and to avoid including structures that are not necessary to the disclosure and that would over complicate the drawings.

### DETAILED DESCRIPTION OF THE INVENTION

The present disclosure provides several examples relating to touch interface devices that are intended to provide multi-point haptics by use of simultaneous sensing and actuation (SSA) in a surface haptic device (SHD), and electronic controllers therefor. The touch interface devices include a substrate to which electrodes are connected, and a controller operably connected with the electrodes for generating haptic effects and sensing finger location. A controller may utilize any of the approaches disclosed herein and be configured to operate with many patterns of electrodes.

Still needed, however, is a suitable method for modulating the magnitude of the electrostatic force. In principle, there are numerous approaches. For example, one approach is to change the magnitude of the voltage applied to the electrodes. Another is to control applied voltage or current based on a measure of the electrical charge on the electrodes 20, 22. In order to achieve high energy efficiency and to be compatible with miniaturized or miniaturizable electronic circuits, however, it is desirable to use methods that employ a small number (preferably two) of voltage levels and rapid switching of those voltages (via, for instance, field effect transistors). The present inventors describe such an electronic controller and associated methods in a co-pending application entitled Electronic Controller For Haptic Display With Simultaneous Sensing And Actuation.

Additionally, there is a frequency dependence of the electrostatic force provided by the electrodes, as a function of voltage, that must be considered. As discussed in the aforementioned co-pending U.S. patent application Ser. No. 13/468,818, entitled Electrostatic Multi-touch Haptic Display, the electrostatic force varies as a square of the voltage, but the finite resistivity of the skin ensures that the effective voltage decays according to a time constant that may be as short as 100 microseconds. For this reason, it is desirable to use an AC voltage excitation. For example, a 20 kHz square wave of voltage that switches between +Vₒ and −Vₒ will produce an electrostatic force that is steady and proportional to Vₒ².

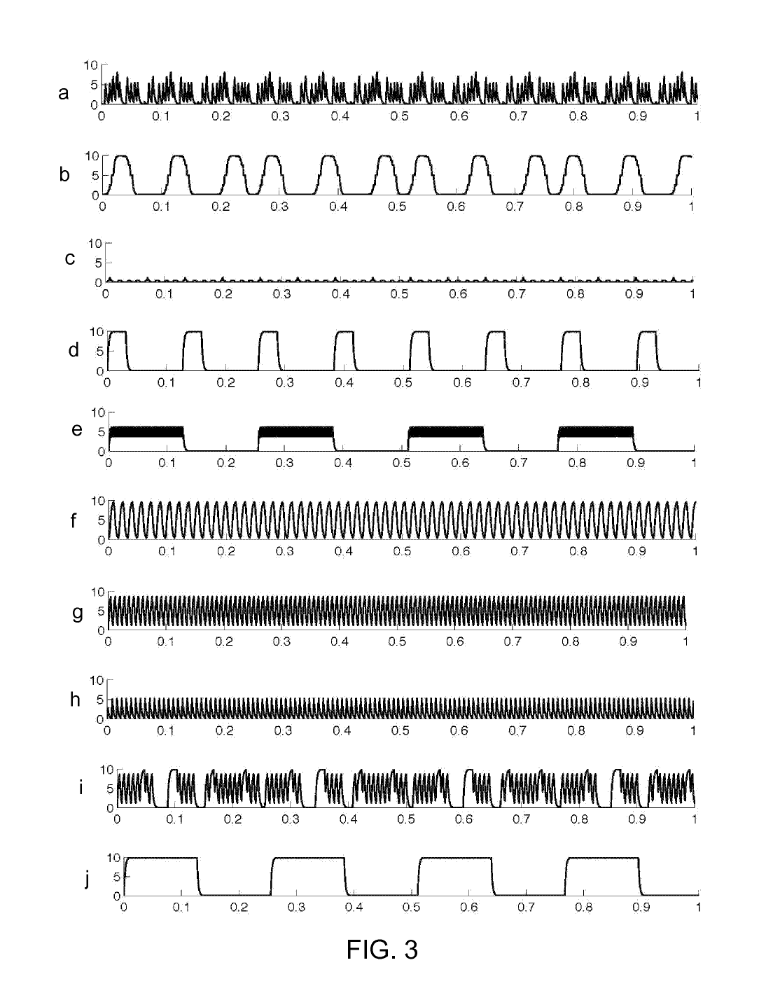

From the standpoint of haptics, it is desirable to be capable of producing a wide variety of waveforms. For instance, if F_{N} is the electrostatic normal force, it is desirable to produce waveforms as a function of time (F_{N}(t)) of a diverse nature: sinusoids of various frequencies, square and triangle waves, band-limited white noise, colored noise, assorted rhythmic patterns, and so on. Ten different sample waveform patterns a-j are illustrated in FIG. 3, where the vertical axis represents electrostatic force and the horizontal axis represents time. It is desirable that an effective haptic actuation method be able to track all of the example waveforms shown, and many others that might be conceived for special purposes.

As an aside, it often may be desirable to vary the electrostatic force as a function of the finger position or velocity, or some other variable, such as the position of a virtual object in a computer game. This does not alter the effectiveness of the invention described herein, because all of those other variables are still functions of time. If the force is dependent on finger position, for example, a real-time computation of the desired force is needed (because the finger moves in real time), but the result is still a waveform, F_{N}(t), that must be tracked.

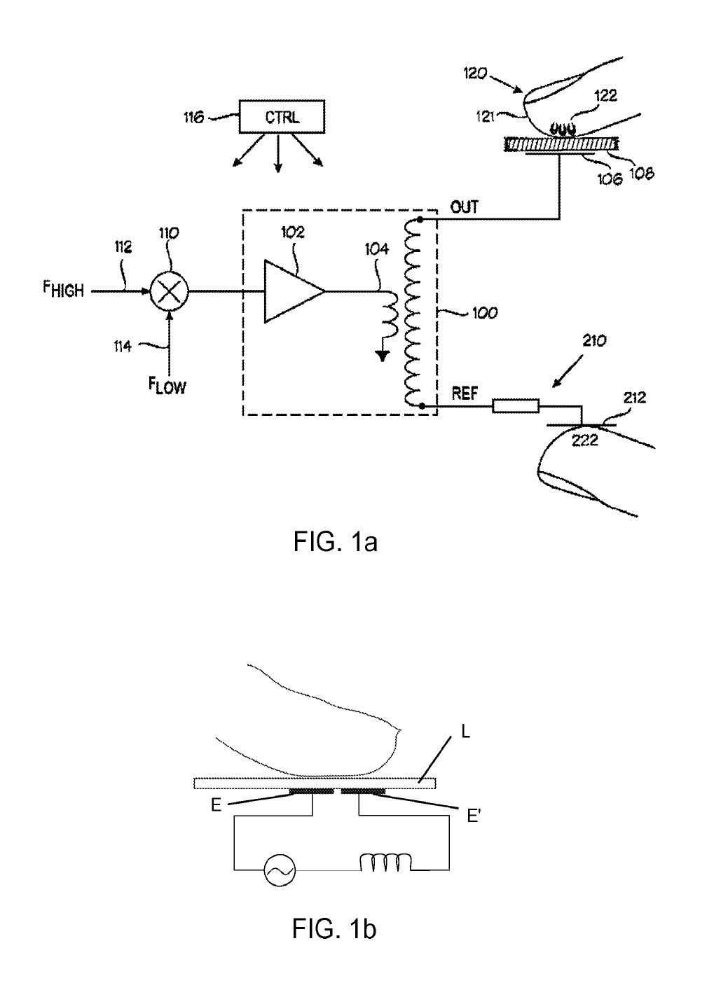

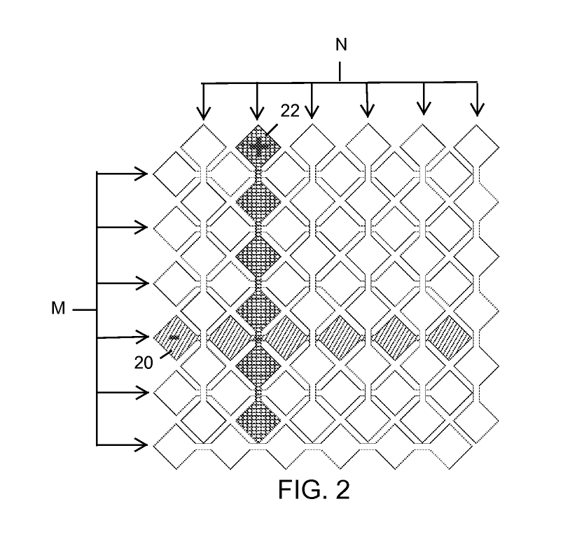

The present invention is a system and method for controlling an electrostatic haptic device that is: 1) composed of short voltage pulses so that the electrostatic force does not have time to decay; 2) based on a small number of voltage levels so that it is compatible with high efficiency, low cost electronics; and 3) capable of emulating essentially any normal force waveform that is haptically perceptible. This invention is described herein with reference to a device incorporating the latticework of electrodes illustrated in FIG. 2, but it is compatible with any electrode geometry and any number of electrodes. It is compatible with arrangements in which the field is returned through a second part of the body, as shown in FIG. 1a, or through the same part of the body as shown in FIG. 1b.

In a preferred embodiment of the electronics, one or more application specific integrated circuits (ASICs), microcontrollers (MCU) or general purpose processors (GPPU) are used to coordinate the actuation of electrodes and sensing of finger touching positions, and to communicate to another general purpose processor (GPPU) or other computing device, such as a personal computer (PC), tablet computer or smart phone. The communication can be via Universal Serial Bus (USB), which is appropriate for a PC peripheral device, or the communication can be by an embedded protocol such as I2C or serial peripheral interface bus (SPI) for a GPPU connection. The bi-directional communication includes requests from the GPPU or PC for haptic effects to be produced and providing information about finger touch positions to the GPPU or PC.

In a preferred embodiment for the haptics output, a GPPU or other computing device conveys waveform values to the MCU and/or GPPU, where they are translated into pulse trains according to the methods taught herein. These pulse trains are applied as voltages to the selected x-axis and y-axis lines of electrodes, thereby producing haptic effects. In an alternative embodiment, waveforms are stored locally on the MCU and/or GPPU, where they are translated into pulse trains applied to the electrodes according to the methods taught herein, thereby producing haptic effects. In this alternative embodiment, a GPPU or other computing device may send commands to the MCU and/or GPPU to select particular waveforms to display.

In a preferred embodiment, the pulse trains producing haptic effects via the electrodes have only two voltage levels, a positive voltage and a negative voltage. In order to control voltages to the electrodes, with those voltages being out of the normal range of logic integrated circuits, the MCU and/or GPPU communicates to other integrated circuits (henceforth, called “flying ICs”) that can control those voltages to the electrodes. In a preferred embodiment, there are two flying ICs, one that can control positive voltages to the electrodes and one that can control negative voltages to the electrodes. In a preferred embodiment, the flying ICs are either MCUs or GPPUs or other digital logic (including programmable digital logic). Other electronic and communication architectures can also be used to create and control the voltages applied to the electrodes.

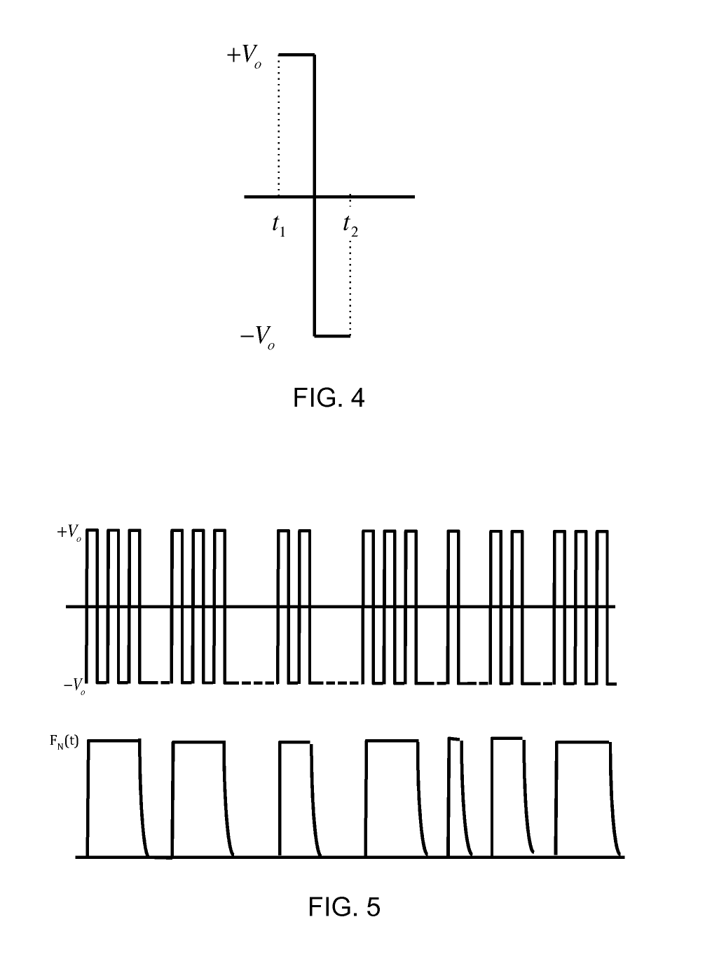

In a preferred embodiment, all pulse trains are built up from a basic pulse of the sort shown in FIG. 4, which shows a single pulse of voltage on a single electrode. The pulse begins by setting the electrode to the voltage +Vₒ at time t₁. At some point prior to time t₂ (preferably (t₁+t₂)/2), the voltage is switched to −Vₒ. At time t₂, the pulse is complete. The electrode can either remain at voltage −Vₒ or it can be disconnected from any voltage source and allowed to float. In a preferred embodiment, the duration of the pulse, t₂−t₁, is 50 microseconds. A train of these pulses, one immediately after the last, would produce a 20 kHz square wave. 20 kHz is a desirable frequency because it is far too fast to be haptically detectable, and it is ultrasonic, so that any vibrations caused by the interaction of such a pulse train with the finger will not be audible. Nonetheless, shorter or longer pulses may be used without altering the principles taught herein.

Using sequences of pulses of the sort illustrated in FIG. 4, the type of voltage waveforms that can be produced is illustrated in FIG. 5. The upper diagram in FIG. 5 shows the voltage applied to an electrode. The voltage is either composed of trains of pulses like that shown in FIG. 4, or it is allowed to float. The electrostatic normal force depends on the square of the voltage. When the voltage is floating, the force decays rapidly to zero. The lower diagram shows a force profile that will, in general, not be that perceived by the finger touching the touch interface because it may be switching from a high state to a low state more rapidly than can be felt. What is perceived is some low-pass filtered version of the force waveform. Pulses may be repeated for an arbitrary number of cycles, and pulses may be suspended for an arbitrary length of time. So long as the pulses are continued, an electrostatic force is produced by the electrodes, but when the pulses cease, the force decays rapidly to zero.

The challenge, therefore, is to produce complex haptic effects of the sort illustrated in FIG. 3, using only the types of pulse train illustrated in FIG. 5. It is important to understand that the two waveforms do not need to be identical. It is only important that they are perceptually equivalent or similar.

The properties of the human perceptual system are, therefore, essential to the proper functioning of the invention. In particular, use is made of the fact that tactile perception is band-limited. Sensitivity to sinusoidal excitation increases as the frequency increases from about 10 Hz to about 300 Hz. As the frequency of excitation continues to increase beyond 300 Hz, the sensitivity begins to decrease. The human fingertip has very little sensitivity to excitations at frequencies greater than about 500 Hz. For this reason the fingertip may be modeled as a low pass filter having a bandwidth of about 500 Hz. With this in mind, a waveform of the sort shown in the lower diagram in FIG. 5 is said to be perceptually equivalent to a waveform of the sort shown in FIG. 3 if, when passed through a 500 Hz low pass filter, it is equivalent. However, frequencies above 500 Hz are still perceptible by other senses; specifically, the audible range of frequencies extends to about 20,000 Hz. It is desirable to avoid any frequencies that may be audible. Also, certain types of modulation generate sub-harmonics which may also be able to be perceived. In the end, the cutoff frequency of the low pass filter needs to be adjusted with these constraints in mind.

There remains the following challenge: given a desired waveform (e.g., one of the waveforms selected from FIG. 3), how should the appropriate voltage pulse train (FIG. 5) be generated? Moreover, this computation should be done in real time since the desired waveform often is generated in real time. Before presenting a solution to this challenge, note one additional factor: the strength of the electrostatic force provided by the electrodes also depends on the area of contact by the finger touch, and the fingertip typically is touching not just a single pair of overlapping electrodes (i.e., from the x-axis and y-axis lines of electrodes in FIG. 2), but multiple electrodes. For instance, a finger near the intersection of the x-axis and y-axis lines of electrodes 20, 22 in FIG. 2 also may be partially overlapping the electrodes to the right and left of the y-axis electrode 22, and to the top and bottom of the x-axis electrode 20. This provides another way to adjust the strength of the electrostatic normal force, by applying pulses to a greater or lesser number of electrodes.

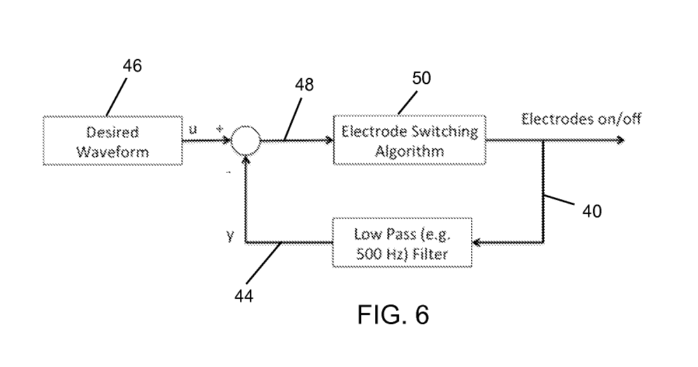

Our solution to the challenge stated above is illustrated in a block diagram of the algorithm for emulating a desired waveform, as shown in FIG. 6. The design takes a representation of the actual waveform at 40 and, in real time, passes it through a Low Pass Filter 42 that is as close as possible to the perceptual low pass filter (although other filters may be used), then compares the result 44 to the Desired Waveform 46. This produces an error signal at 48 that is sent to an Electrode Switching Algorithm 50 to determine whether at a particular time the Desired Waveform 46 is greater than the output 44 of the Low Pass Filter 42 from the actual waveform 40. Based on this error signal 48 that is sent to the Electrode Switching Algorithm 50, one of two things can happen: pulses can be continued or discontinued on a given electrode, and the number of electrodes receiving pulses can be increased or decreased.

In a preferred embodiment, the Desired Waveform 46 is defined as a series of values at 1 millisecond intervals. Each of these values can be an integer between 0 and 255 (in other words, the value is an 8 bit number). Also in a preferred embodiment, at least one set of electrodes can be recruited to modify the strength of the electrostatic normal force. It will be appreciated that an increased number of sets of electrodes will increase the strength of the electrostatic normal force. A “set” of electrodes, here, is one x-axis electrode 20 and one y-axis electrode 22, as illustrated in FIG. 2.

The Electrode Switching Algorithm 50 consists of two parts that work together to decide what pulses to apply to what electrodes. The first part is a modified “bang-bang” controller. The bang-bang controller works as follows: if at a particular time tₖ the Desired Waveform 46 is greater than the output 44 of the Low Pass Filter 42, a pulse should be sent; if the Desired Waveform 46 is less than the output 44 of the Low Pass Filter 42, a pulse should not be sent. This can be modified, however, to account for the use of up to three electrode sets. For instance, if the magnitude of the Desired Waveform is greater than one-third of its maximum value, then a pulse should always be sent to at least one electrode set. If, in addition, the magnitude of the Desired Waveform is greater than the output of the Low Pass Filter, then pulses should be sent to two electrode sets.

The second part of the algorithm modifies this further in response to the size of the difference between the Desired Waveform 46 and the output 44 of the Low Pass Filter 42. The basic formulation considers that, as the difference grows, it may be necessary to send pulses to even more (or fewer, depending on the sign of the difference) electrode sets.

Pseudo code for the Electrode Switching Algorithm 50, based on a maximum value of the Desired Waveform of 255 and three electrode sets, is shown below. It should be understood that this is only representative, and the algorithm can be modified to account for different values of the maximum, and different numbers of electrode sets.

### Definitions

uₖ=amplitude of desired waveform at time tₖ

yₖ=output of low pass filter at time tₖ

eₖ=uₖ−yₖ

xₖ=input to the low pass filter at time tₖ

sₖ=output to electrodes
sₖ=0 if no pulse is to be sent at time tₖ
sₖ=1 if a pulse (FIG. 2) is to be sent to electrode set 1 at time tₖ
sₖ=2 if a pulse is to be sent to electrode sets 1 and 2 at time tₖ
sₖ=3 if a pulse is to be sent to electrode sets 1, 2 and 3 at time tₖ

threshold=magnitude of |uₖ₋₁−yₖ₋₁| beyond which more/fewer electrodes should be pulse

### Algorithm

```
At time tₖ, do the following:
\\ Compute the error from the previous time step
eₖ₋₁ = uₖ₋₁ − yₖ₋₁
\\ Based on uₖ, eₖ₋₁ and yₖ₋₁, decide how many electrode
sets to pulse
If uₖ < 85 then:
  \\ bang-bang
  If uₖ₋₁ − yₖ₋₁ < 0, set sₖ = 0
  If uₖ₋₁ − yₖ₋₁ > 0, set sₖ = 1
    \\ modify based on error magnitude
    if eₖ₋₁ < -threshold, set sₖ = 0
    if eₖ₋₁ > threshold, let sₖ = 2
    if eₖ₋₁ > 2*threshold, let sₖ = 3
If 85 <= uₖ < 170 then:
  \\ bang-bang
  If uₖ − yₖ₋₁ < 0, set sₖ = 1
    \\ modify based on error magnitude
    if eₖ₋₁ < -threshold, set sₖ = 0
    if eₖ₋₁ > threshold, let sₖ = 2
    if eₖ₋₁ > 2*threshold, let sₖ = 3
  If uₖ − yₖ₋₁ > 0, set sₖ = 2
    \\ modify based on error magnitude
    if eₖ₋₁ < -2*threshold, set sₖ = 0
    if eₖ₋₁ < -threshold, set sₖ = 1
    if eₖ₋₁ > threshold, let sₖ = 3
If uₖ >= 170 then:
  \\ bang-bang
  If uₖ − yₖ₋₁ < 0, set sₖ = 2
    \\ modify based on error magnitude
    if eₖ₋₁ < -2*threshold, set sₖ = 0
    if eₖ₋₁ < -threshold, set sₖ = 1
    if eₖ₋₁ > threshold, let sₖ = 3
  If uₖ − yₖ₋₁ > 0, set sₖ = 3
    \\ modify based on error magnitude
    if eₖ₋₁ < -3*threshold, set sₖ = 0
    if eₖ₋₁ < -2*threshold, set sₖ = 1
    if eₖ₋₁ < -threshold, set sₖ = 2
\\ Compute input to filter
Let xₖ = 85*(s1ₖ + s2ₖ + s3ₖ)
\\ Based on xₖ and yₖ₋₁, use low pass filter to compute yₖ
yₖ = Filter(xₖ, yₖ₋₁)
```

In a preferred embodiment, the filter or Low Pass Filter is first order with a bandwidth that optimizes the performance, but other filters, including those that might better match human perceptual characteristics, may also be used.

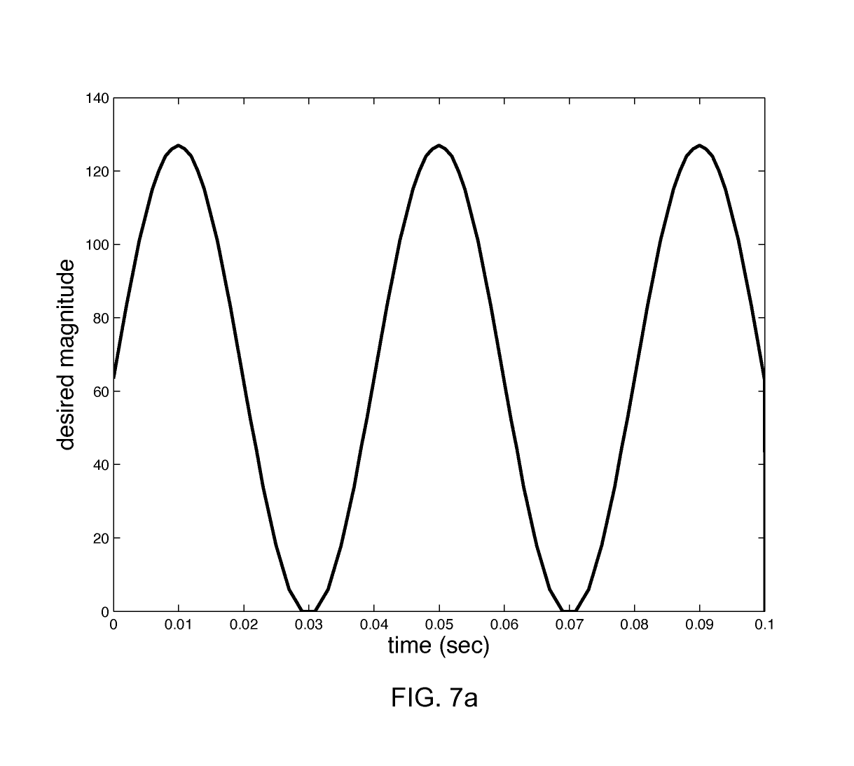

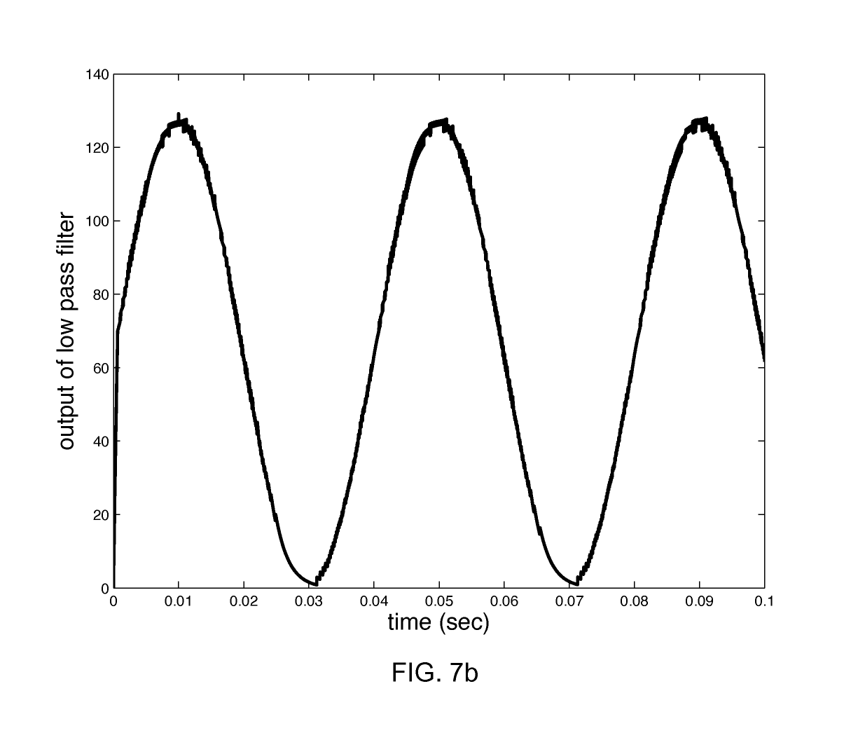

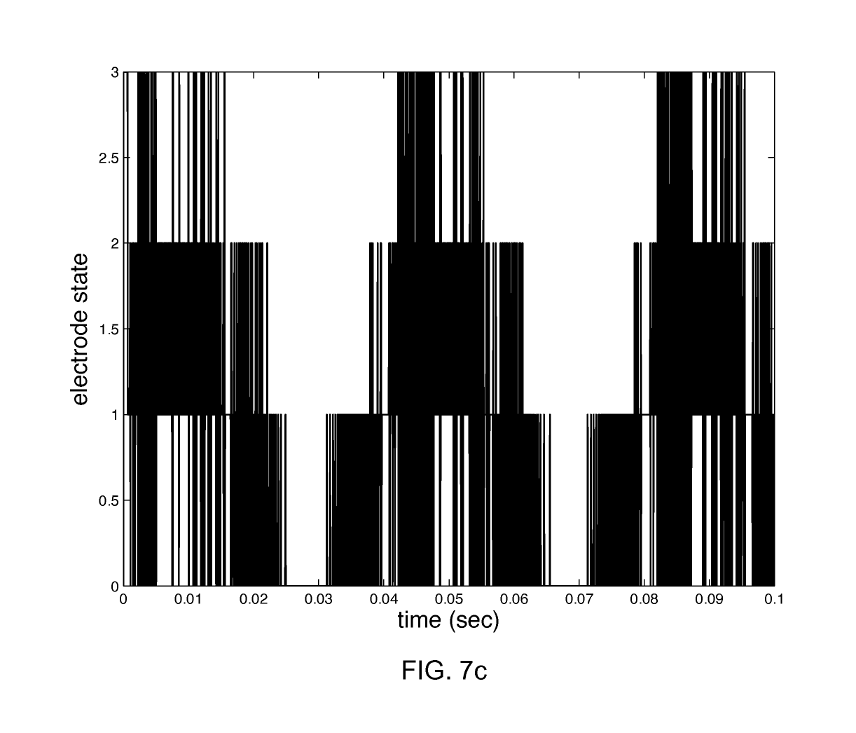

The value of this algorithm is illustrated in FIGS. 7a-7c. In this example, FIG. 7a shows the Desired Waveform is a 25 Hz sinusoid having a minimum value of 0 and a maximum value of 128. This type of smoothly varying waveform is difficult for a switched system to track. FIG. 7b shows the output of the Low Pass Filter, which is an approximation of what is perceived and evidently is similar to or tracks the desired waveform quite closely. The input to the Low Pass Filter, which represents the states of the electrodes, is shown in FIG. 7c. This waveform is clearly discretized. Its value represents the number of electrodes receiving pulses at a particular instant (0, 1, 2 or 3).

From the above disclosure, it will be apparent that touch interfaces of surface haptic devices constructed in accordance with this disclosure may provide multi-point haptics while including a number of advantages over the prior art. The devices may exhibit one or more of the above-referenced potential advantages, depending upon the specific design and configuration chosen.

It will be appreciated that a touch interface of a surface haptic device having multi-point haptics in accordance with the present disclosure may be provided in various configurations. Any variety of suitable materials of construction, configurations, shapes and sizes for the components and methods of connecting the components may be utilized to meet the particular needs and requirements of an end user. It will be apparent to those skilled in the art that various modifications can be made in the design and construction of such devices without departing from the scope or spirit of the claimed subject matter, and that the claims are not limited to the preferred embodiments illustrated herein.

It is to be understood that the above description is intended to be illustrative, and not restrictive. For example, the above-described examples or embodiments (and/or aspects thereof) may be used individually or in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are intended as examples. Many other embodiments will be apparent to one of ordinary skill in the art upon reviewing the above description. The scope of the one or more embodiments of the subject matter described herein should, therefore, be determined with reference to the appended claims, along with the full scope of equivalents to which such claims are entitled. In the appended claims, terms such as “including” and “having” are used as the plain-English equivalents of the respective terms “comprising” and “wherein.” Moreover, in the following claims, use of terms such as “first,” “second,” and “third,” etc. may be used merely as labels, and are not intended to impose numerical requirements on their objects. Further, the limitations of the following claims are not written in means-plus-function format and are not intended to be interpreted based on 35 U.S.C. 112, sixth paragraph, unless and until such claims limitations expressly use the phrase “means for” followed by a statement of function void of further structure.

This written description uses examples to disclose several embodiments of the inventive subject matter, and also to enable a person of ordinary skill in the art to practice the embodiments disclosed herein, including making and using any devices or systems and performing any incorporated methods. The patentable scope of the subject matter may be defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal language of the claims.

As used herein, an element or step recited in the singular and proceeded with the word “a” or “an” should be understood as not excluding plural of said elements or steps, unless such exclusion is explicitly stated. Furthermore, references to one example of embodiment of the presently described inventive subject matter are not intended to be interpreted as excluding the existence of additional examples or embodiments that also incorporate the recited features. Moreover, unless explicitly stated to the contrary, claims “comprising,” “including,” or “having” an element or a plurality of elements having a particular property may include additional such elements not having that property.

What is claimed is:

1. A controller for a surface haptic device that generates haptic waveforms, wherein the controller comprises a signal generator and a low pass filter, and the controller automatically determines an on/off state of each of one or more surface haptic actuators such that a low pass filtered version of the on/off state closely approximates a desired waveform.

2. A method of generating desired haptic waveforms on a touch interface of a surface haptic device having a substrate and one or more electrodes connected to a front surface of the substrate comprising: passing a representation of an actual waveform in real time through a low pass filter; comparing a resulting signal to a desired waveform; generating an error signal that depends on whether the low passed actual waveform is less than or greater than the desired waveform; utilizing the error signal in continuing or discontinuing pulses on a given electrode and/or increasing or decreasing the number of electrodes receiving pulses.

3. The method of generating desired haptic waveforms on a touch interface of claim 2 wherein the method further comprises utilizing at least one set of electrodes to modify a strength of an electrostatic normal force on the substrate.

4. The method of generating desired haptic waveforms on a touch interface of claim 2 wherein the method further comprises utilizing an electrode switching algorithm.

5. The method of generating desired haptic waveforms on a touch interface of claim 4 wherein a controller utilizes the electrode switching algorithm to determine whether at a particular time the desired waveform is greater than an output of the low pass filter and if so, then a pulse is sent to the electrode, and if not a pulse is not sent.

6. The method of generating desired haptic waveforms on a touch interface of claim 5 wherein the controller further utilizes the electrode switching algorithm to modify the response to send pulses to more or fewer electrodes depending on the size difference between the desired waveform and the output of the low pass filter.
